(19) United States
(12) Patent Application Publication
(10) Pub. No.: US 2026/0091715 A1
(43) Pub. Date: Apr. 2, 2026

(54) BACK FRAME

(71) Applicant: TOYOTA BOSHOKU KABUSHIKI KAISHA, Aichi (JP)

(72) Inventor: Keisuke YAMAMOTO, Toyota-shi (JP)

(73) Assignee: TOYOTA BOSHOKU KABUSHIKI KAISHA, Aichi (JP)

(21) Appl. No.: 19/333,588

(22) Filed: Sep. 19, 2025

(30) Foreign Application Priority Data
Sep. 27, 2024 (JP) 2024-168582

(51) Int. Cl. B60N 2/64; B60N 2/02

(52) U.S. Cl. CPC B60N 2/64; B60N 2/02253; B60N 2205/50

(57) ABSTRACT

A back frame of a vehicle seat includes: first and second side frames respectively arranged on one end side and the other end side in seat-width directions; a first coupling member extending in the seat-width directions and coupling upper end portions of the first and second side frames; a recliner fixed to a lower end portion of the first side frame; and a second coupling member extending in the seat-width directions and coupling the lower end portions of the first and second side frames. The second coupling member is joined to the first side frame at a front joined area and a rear joined area, and the front joined area is positioned at a location corresponding to a joined area between the recliner and the first side frame.

### CROSS-REFERENCE TO RELATED APPLICATIONS

This application claims the benefit of Japanese Patent Application No. 2024-168582 filed on September 27, 2024 with the Japan Patent Office, and the entire disclosure of which is incorporated herein by reference.

### BACKGROUND

The present disclosure relates to a back frame to be used in a seatback of a vehicle seat.

For example, a back frame disclosed in Japanese Unexamined Patent Application Publication No. 2008-194289 comprises a round pipe formed into a U-shape by bending, a pipe extending in seat-width directions and coupling portions of the round pipe with each other, the portions extending in up-down directions, and the like.

### SUMMARY

The present disclosure discloses an example of a back frame capable of inhibiting deformation of a part of the back frame extending in seat up-down directions (hereinafter, referred to as a “side frame”) due to an external force acting on the part to twist the same.

What is meant by the “deformation of the side frame to twist the same” is, for example, torsional deformation centered around an imaginary axis that passes through a centroid of a cross-section of the side frame and extends in a longitudinal direction of the side frame.

It is desirable that a back frame used in a seatback of a vehicle seat according to an aspect of the present disclosure comprises at least one of the following constituent elements, for example.

Specifically, the constituent elements include: a first side frame that is arranged on one end side of the vehicle seat in seat-width directions and that extends in up-down directions; a second side frame that is arranged on the other end side of the vehicle seat in the seat-width directions and that extends in the up-down directions; a first coupling member extending in the seat-width directions and coupling an upper end portion of the first side frame to an upper end portion of the second side frame; a recliner provided to change and maintain angles of the first side frame and the second side frame, the recliner being fixed at least to a lower end portion of the first side frame; and a second coupling member extending in the seat-width directions and coupling the lower end portion of the first side frame to a lower end portion of the second side frame.

It is desirable that the second coupling member is joined to the first side frame at a front portion of the first side frame and at a rear portion of the first side frame, and that a front joined area among joined areas between the second coupling member and the first side frame is positioned at a location corresponding to a joined area between the recliner and the first side frame.

In the configuration as described above, in the back frame, when an external force acts on the first side frame to twist the first side frame, the second coupling member receives torsion torque generated in the first side frame as a tensile force and a compressive force as the second coupling member and the first side frame are joined together.

Torsional deformation is shear deformation, and in general, tensile deformation and compressive deformation can be suppressed more effectively than shear deformation. Therefore, above configuration can inhibit large torsional deformation of the first side frame more effectively than in a configuration where the torsional deformation is resisted solely by the shear stress generated in the first side frame.

The back frame may be configured as below.

Specifically, the recliner is a first recliner, and the back frame further comprises a second recliner fixed to the lower end portion of the second side frame. A front joined area among joined areas between the second coupling member and the second side frame is positioned at a location corresponding to a joined area between the second recliner and the second side frame, and a front-side longitudinally intermediate portion of the second coupling member is positioned rearward relative to both one end and the other end of the second coupling member in a longitudinal direction thereof. This makes it possible to suppress interference between the second coupling member and the seated occupant.

Furthermore, it is desirable that the longitudinally intermediate portion of the second coupling member has a substantially C-shaped cross-section with an open upper side. In a case where the back frame comprises a rod extending in the seat-width directions and coupling the first recliner to the second recliner, it is desirable that the longitudinally intermediate portion of the second coupling member has a substantially C-shaped cross-section to surround the rod.

### BRIEF DESCRIPTION OF THE DRAWINGS

Example embodiments of the present disclosure will be described below with reference to the accompanying drawings, in which:

FIG. 1 is a diagram showing a back frame according to a first embodiment;

FIG. 2 is a diagram showing an upper part of the back frame according to the first embodiment;

FIG. 3 is a diagram showing the back frame according to the first embodiment;

FIG. 4 is a diagram showing a lower beam according to the first embodiment;

FIG. 5 is a diagram showing a joined structure of the lower beam and a first side frame.

FIG. 6 is a diagram showing the joined structure of the lower beam and the first side frame.

FIG. 7 is a diagram showing the joined structure of the lower beam and the first side frame; and

FIG. 8 is a diagram showing the joined structure of the lower beam and the first side frame.

### DETAILED DESCRIPTION OF EXEMPLARY EMBODIMENTS

Embodiments below show examples of embodiments belonging to the technical scope of the present disclosure. Invention-specifying matters and so on recited in the appended claims are not limited by specific configurations, structures, and the like indicated in the below-described embodiments.

The present embodiment is an example in which a back frame according to the present disclosure is applied to a seat to be installed in a vehicle, such as an automobile (hereinafter, referred to as a “vehicle seat”). Arrows indicating directions and diagonal lines shown in the drawings are provided for the purpose of easier understanding of mutual relationships between the drawings, shapes of members or portions and the like.

Thus, a direction of the back frame is not limited by the directions shown in the drawings. The directions shown in the drawings are based on a state where the vehicle seat according to the present embodiment is mounted on an automobile. The drawings with diagonal lines provided thereon are not necessarily cross-sectional views.

A member or portion described at least with a reference numeral is at least one in number except in a case of being accompanied by restrictive words such as “only one”. In other words, the member or portion may be two or more in number in a case of not being accompanied by the restrictive words such as “only one”. The back frame disclosed in the present disclosure comprises at least one of constituent elements such as a member or a portion described at least with a reference numeral or a structural part illustrated.

### First Embodiment

### 1. Overview of Back Frame

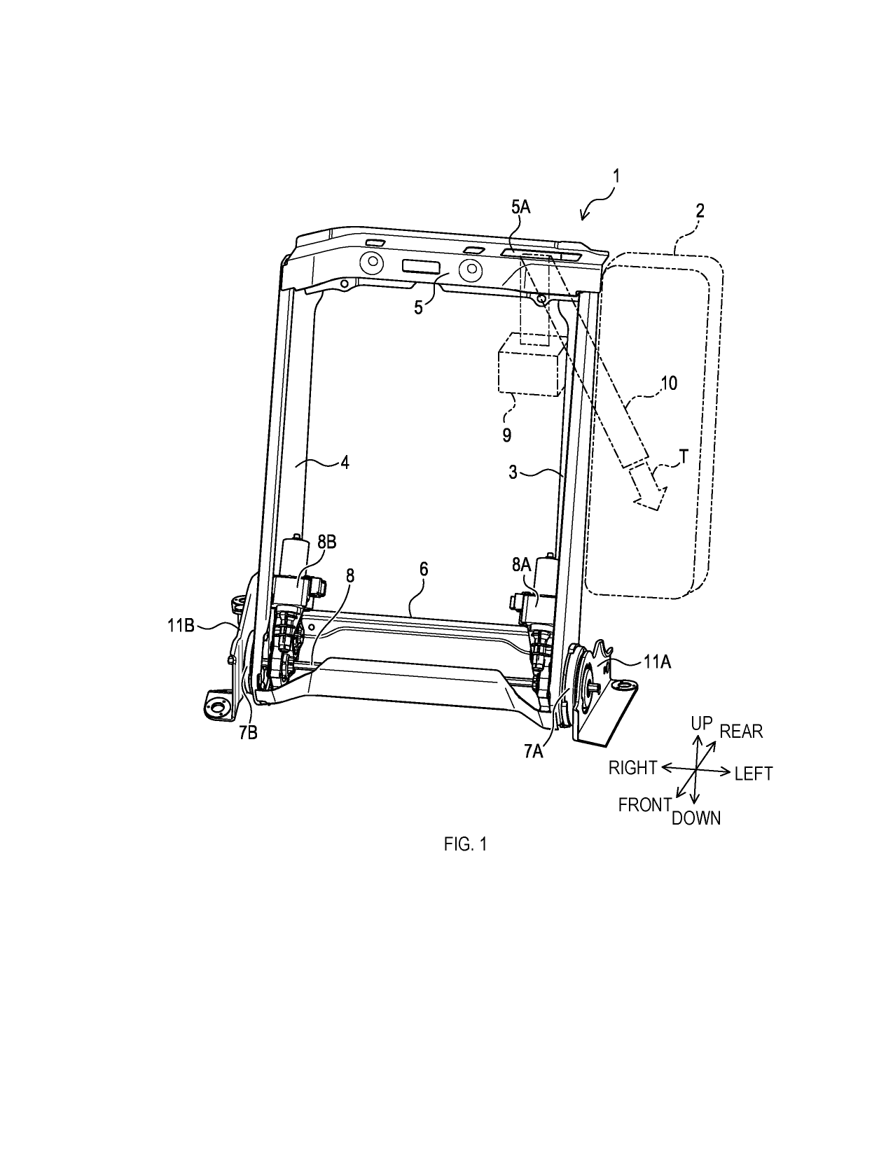

As illustrated in FIG. 1, a back frame 1 according to the present embodiment is one example of a frame that is used in a seatback of a rear seat of a vehicle. Specifically, the back frame 1 is used in a right-side seat of the vehicle rear seat designed for three occupants.

The seatback supports an occupant’s back. The back frame 1 forms a framework of the seatback. In the present embodiment, a frame 2 for a middle seat is coupled to the back frame 1.

### 2. Details of Back Frame

### 2.1 Configuration of Back Frame

The back frame 1 comprises at least a first side frame 3, a second side frame 4, an upper beam 5, a lower beam 6, a first recliner 7A, a second recliner 7B, a rod 8, a back panel (not shown), and the like.

The first side frame 3 is a high-strength member that is arranged on one end side of the vehicle seat in seat-width directions (on a left end side in the present embodiment) and that extends in seat up-down directions. The second side frame 4 is a high-strength member that is arranged on the other end side of the vehicle seat in the seat-width directions (on a right end side in the present embodiment) and that extends in the up-down directions.

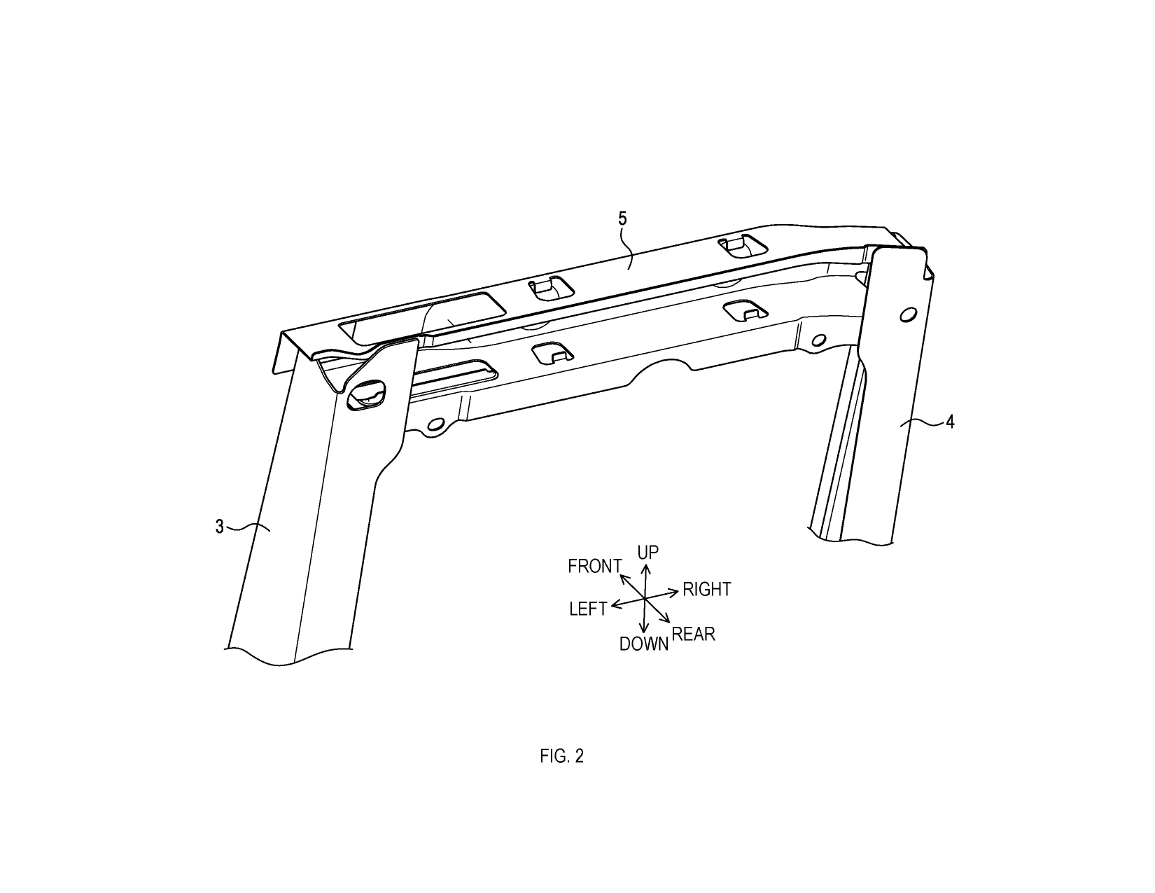

The upper beam 5 is one example of a first coupling member that extends in the seat-width directions and that couples an upper-end portion of the first side frame 3 to an upper-end portion of the second side frame 4. The upper beam 5 is formed to have a substantially U-shaped or C-shaped cross section with an open rear side (see FIG. 2). In the present embodiment, the upper beam 5 is an integrated part manufactured from a single steel sheet using press forming.

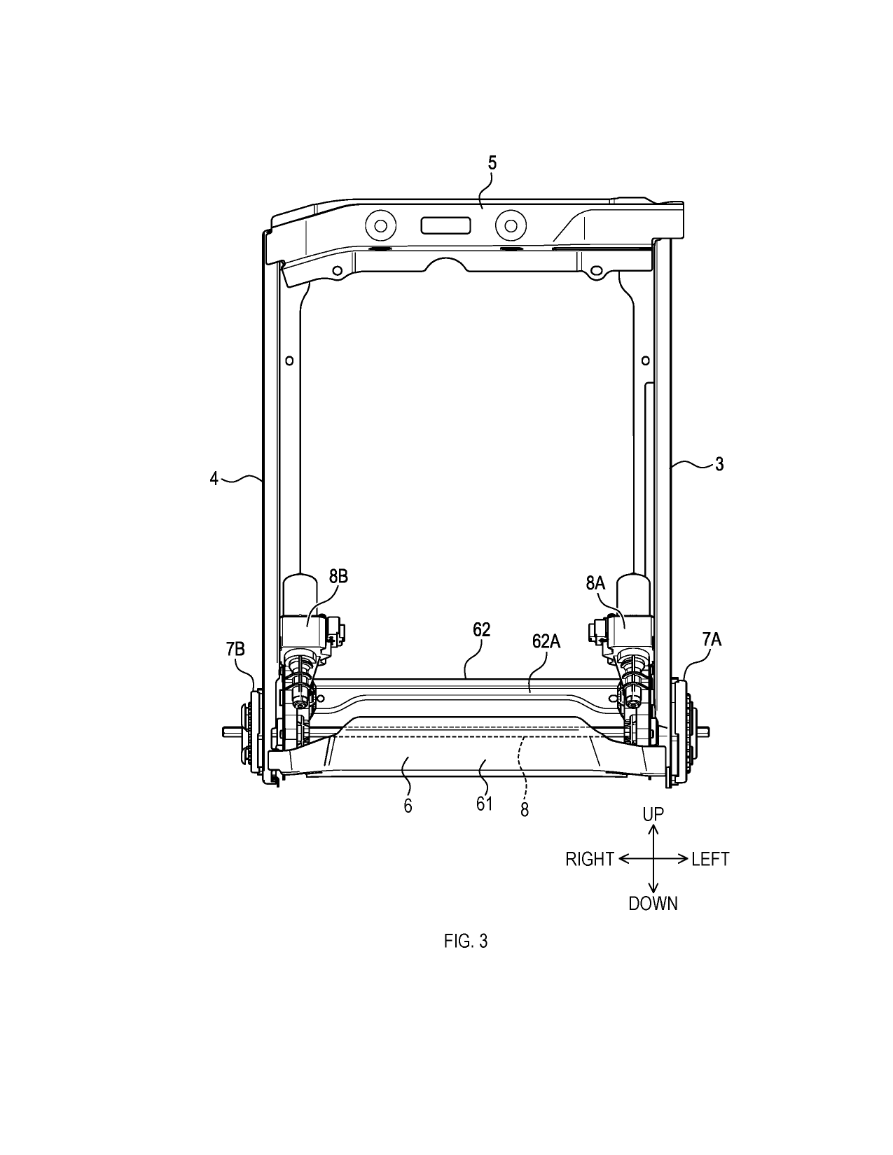

As illustrated in FIG. 3, the lower beam 6 is a lower panel, which is one example of a second coupling member that extends in the seat-width directions and that couples a lower-end portion of the first side frame 3 to a lower-end portion of the second side frame 4. The first side frame 3, the second side frame 4, the upper beam 5, and the lower beam 6 form a frame body with a rectangular frame shape.

The back panel (not shown) is a plate-shaped member that is disposed rearward of the frame body and that covers an entire rear surface of the frame body. As illustrated in FIG. 1, a retractor 9 that winds up a seat belt 10 is fixedly arranged below the upper beam 5 on the back panel.

The upper beam 5 is provided with a belt receiver 5A. The belt receiver 5A is a part of the upper beam 5 where a through hole is provided to allow the seat belt 10 to pass through. When a tensile force T is applied to the seat belt 10, the belt receiver 5A receives the tensile force T.

The first recliner 7A and the second recliner 7B are mechanisms to change and maintain an angle of the back frame 1. Specifically, the first recliner 7A is fixed by welding at one side to a lower end portion of the first side frame 3 and fixed at the other side to the vehicle via a bracket 11A.

The second recliner 7B is fixed by welding at one side to the vehicle via a bracket 11B and fixed at the other side to a lower end portion of the second side frame 4. In the present embodiment, the “one side” refers to the right side, while the “other side” refers to the left side.

The rod 8 extends in the seat-width directions and couples the first recliner 7A to the second recliner 7B. Driving forces generated by electric motors 8A, 8B are transmitted to the first recliner 7A and the second recliner 7B via the rod 8.

### 2.2 Detailed Structure of Lower Beam

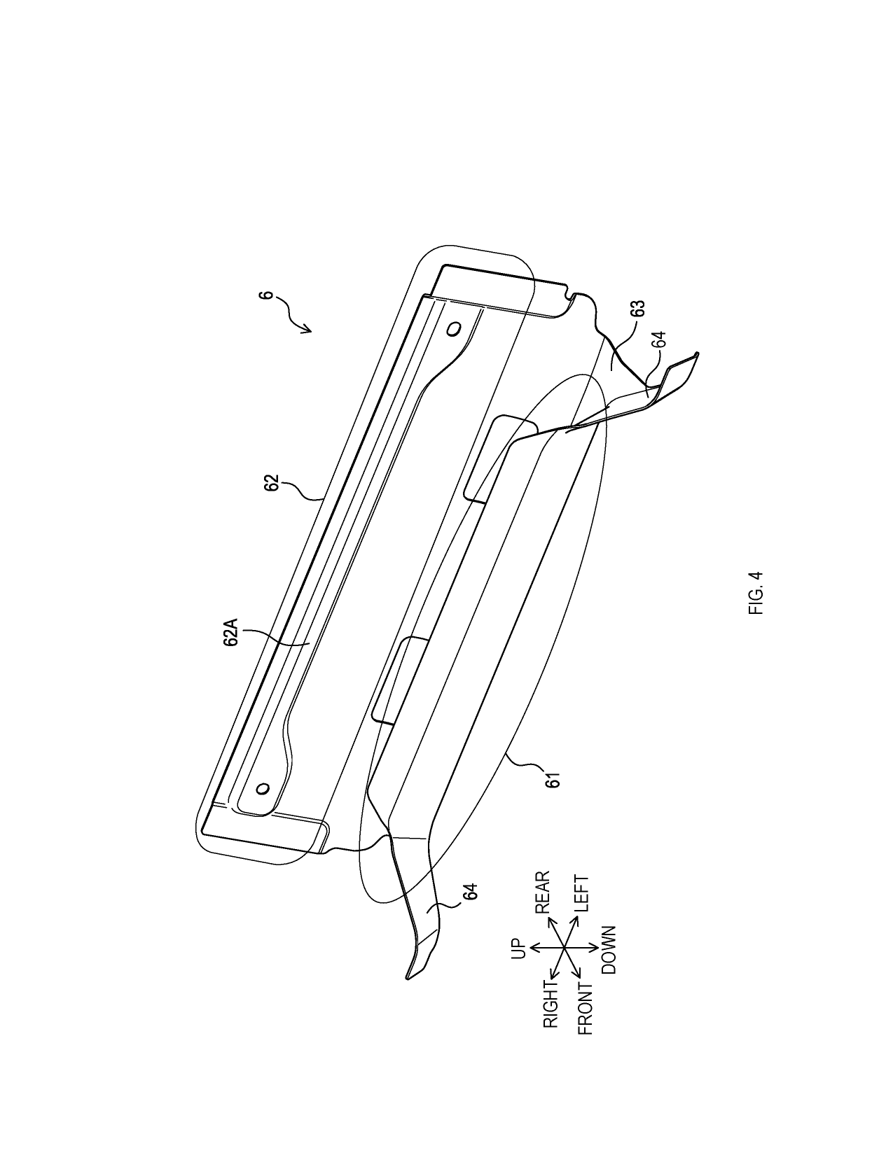

As illustrated in FIG. 4, the lower beam 6 includes a front panel 61, a rear panel 62, a bottom panel 63, and the like. In the present embodiment, the front panel 61, the rear panel 62 and the bottom panel 63 are an integrated part manufactured from a single steel sheet using press forming.

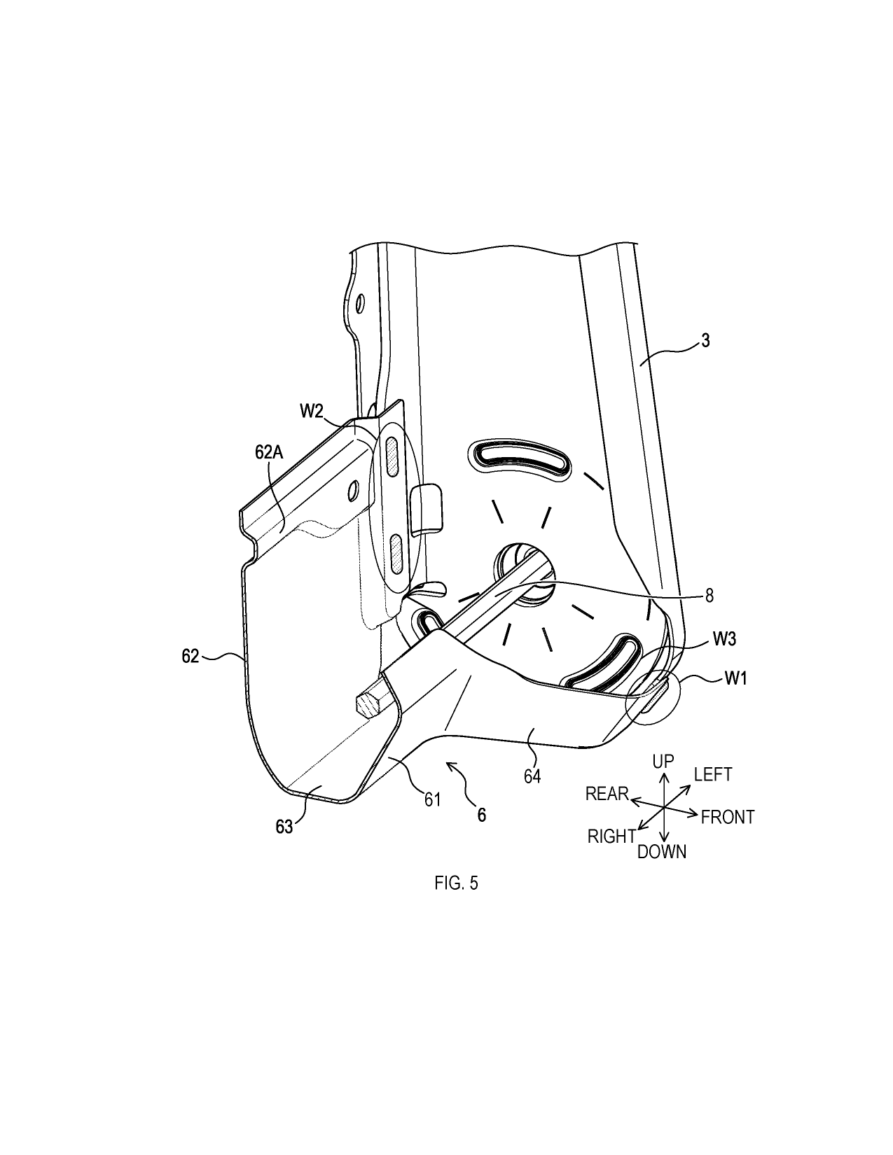

As illustrated in FIG. 5, at least a longitudinally intermediate portion of the lower beam 6 has a substantially C-shaped cross-section with an open upper side. Specifically, the cross-section of the longitudinally intermediate portion has a substantially C-shape with the open upper side so as to surround the rod 8.

The longitudinally intermediate portion of the lower beam 6 refers to a predetermined section including a center of the lower beam 6 in the longitudinal direction (i.e., a midpoint in the longitudinal direction). In the present embodiment, the lower beam 6 has a substantially C-shaped cross-section in a range from a vicinity of the electric motor 8A to a vicinity of the electric motor 8B.

As illustrated in FIG. 4, a longitudinally intermediate portion of the front panel 61 has a shape recessed rearward so as to be positioned rearward relative to both one end and the other end thereof in the longitudinal direction. The recessed shape is provided to avoid interference with the seated occupant’s buttocks.

In the rear panel 62, as illustrated in FIG. 4, a beam 62A is provided that extends in the seat-width directions. As illustrated in FIG. 5, the beam 62A is formed as a protrusion that protrudes in a seat front direction and extends in the seat-width directions. Thus, the beam 62A functions as a reinforcer that improves flexural rigidity of the rear panel 62.

One end portion of the lower beam 6 in the longitudinal direction is joined to the lower end portion of the first side frame 3 by arc welding. The other end portion of the lower beam 6 in the longitudinal direction is joined to the lower end portion of the second side frame 4 by arc welding.

### 2.3 Joined Structure between Lower Beam and Side Frame

The following description is directed to a joined structure between the lower beam 6 and the first side frame 3. In the present embodiment, the joined structure between the lower beam 6 and the first side frame 3, and a joined structure between the lower beam 6 and the second side frame 4 are the same. Thus, description of the joined structure between the lower beam 6 and the second side frame 4 will be omitted.

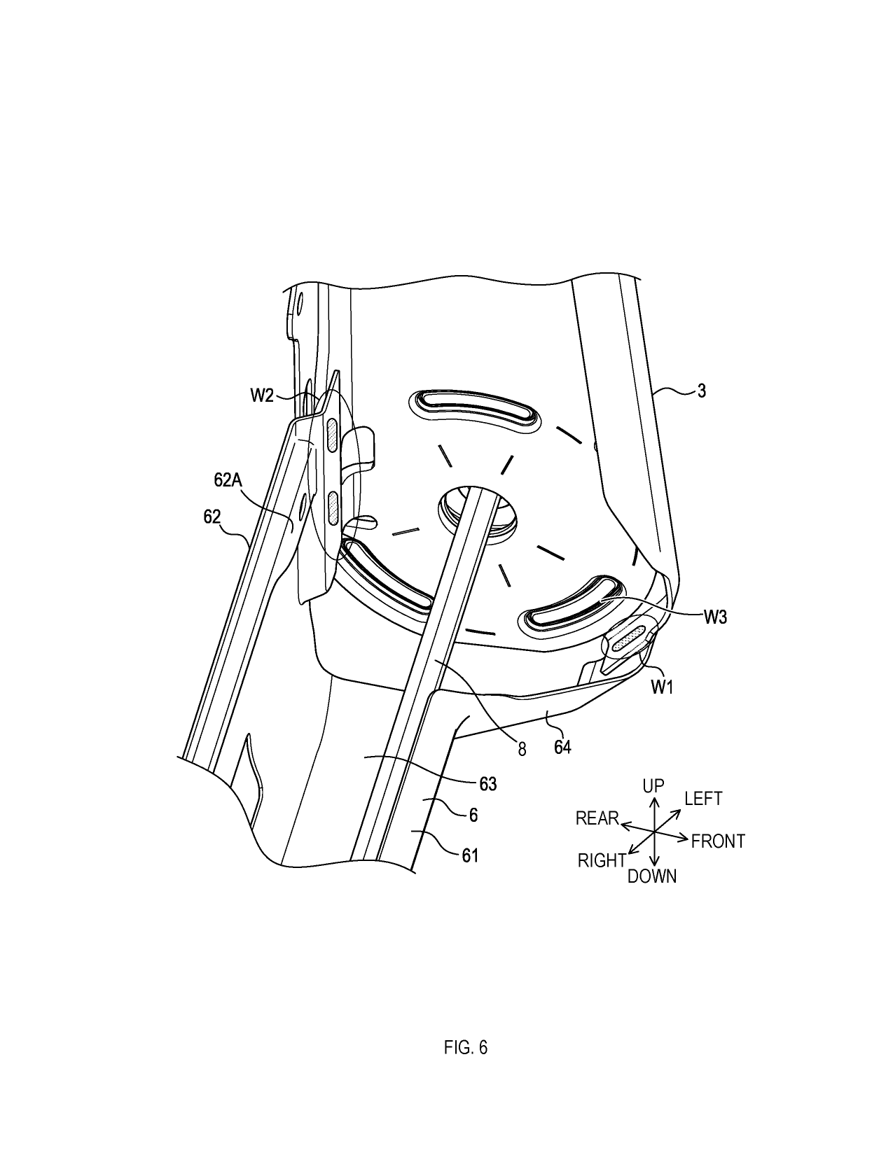

As illustrated in FIG. 6, the lower beam 6 is provided with a first joined portion W1, a second joined portion W2, and the like. The first joined portion W1 is joined to a front portion of the first side frame 3. The second joined portion W2 is joined to a rear portion of the first side frame 3.

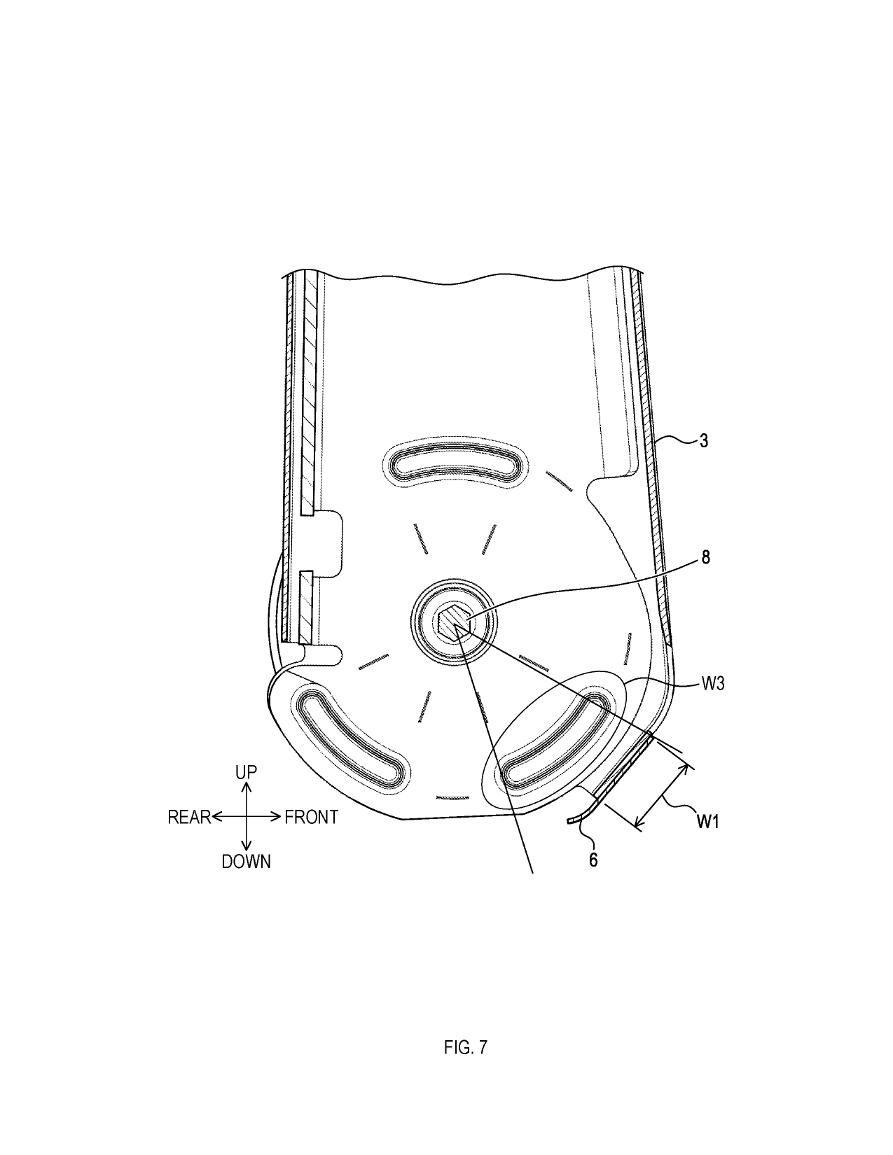

As illustrated in FIG. 7, the first joined portion W1 is located at a position corresponding to a joined area W3 between the first recliner 7A and the first side frame 3. An example of the first joined portion W1 being located at a position corresponding to the joined area W3 is shown in the following configuration.

Specifically, the configuration refers to a state in which the first joined portion W1 lies within a sector-shaped area with a radius expanded from a radius of a sector form representing a joint range. The joint range refers to a sector-shaped area whose center coincides with a center of the first recliner 7A (in the present embodiment, a center of the rod 8), and whose arc length corresponds to a longitudinal length of the arc-shaped joined area W3.

3. Characteristics of Back Frame of the Present Embodiment

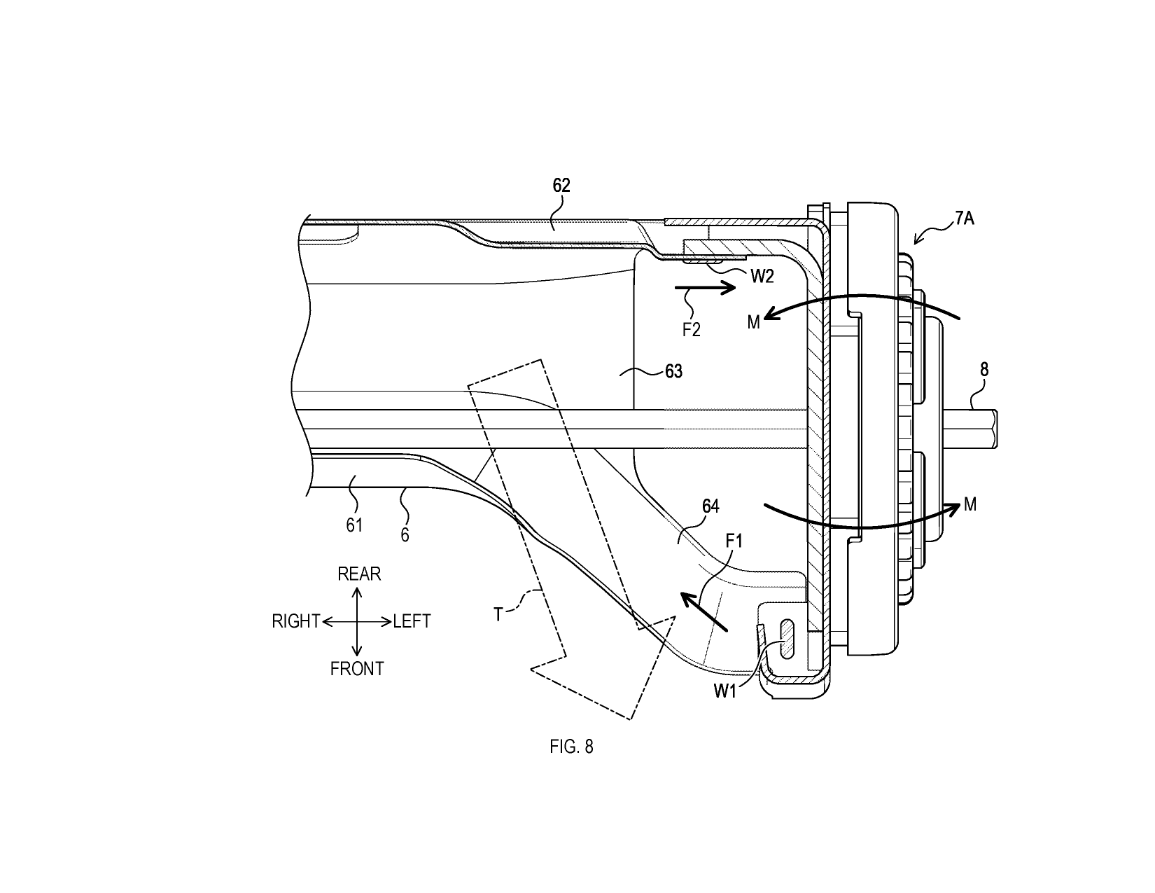

When the tensile force T is applied to the seat belt 10, the back frame 1 receives the tensile force T with the belt receiver 5A. Thus, as illustrated in FIG. 8, a stress is generated in the first side frame 3 to cause a torsional deformation in the first side frame 3 to twist the same.

In the back frame 1 of the present embodiment, the first joined portion W1, which is located in front among the joined areas between the lower beam 6 and the first side frame 3, is positioned at a location corresponding to the joined area W3 between the first recliner 7A and the first side frame 3.

Therefore, in the back frame 1, when a stress is generated in the first side frame 3 to cause a torsional deformation in the first side frame 3 to twist the same, the lower beam 6 receives torsion torque M generated in the first side frame 3 as a tensile force F1 and a compressive force F2, as the lower beam 6 and the first side frame 3 are joined at the first joined portion W1 and the second joined portion W2.

Torsional deformation is shear deformation, and in general, tensile deformation and compressive deformation can be suppressed more effectively than shear deformation. Thus, the present embodiment can inhibit large torsional deformation of the first side frame 3 more effectively than in a configuration where the torsional deformation is resisted solely by shear stress generated in the first side frame 3.

Furthermore, a front-side longitudinally intermediate portion of the lower beam 6 is positioned rearward relative to both one end and the other end thereof in the longitudinal direction. This makes it possible to suppress interference between the lower beam 6 and the seated occupant. For this reason, the first joined portion W1 in the present embodiment is provided at a leading end of an arm 64 that extends from each of one end and the other end of the front panel 61 in the longitudinal direction.

### Other Embodiments

In the above-described embodiment, the first joined portion W1, the second joined portion W2, and the joined area W3 are joined by arc welding. However, the present disclosure is not limited to this. Specifically, the present disclosure may have a configuration of, for example, bonding the joints using an adhesive agent.

In the above-described embodiment, the recliner and the electric motor are provided two in number, respectively. However, the present disclosure is not limited to this. Specifically, in the present disclosure, for example, each of the recliner and the electric motor may be one in number, the recliner may be two in number while the electric motor is one in number, or there may be no electric motor.

In the above-described embodiment, the back frame 1 comprises the back panel made of metal. However, the present disclosure is not limited to this. Specifically, the present disclosure may be applicable, for example, to a back frame in which the back panel is not used, or to a back frame equipped with a back panel made of resin.

In the above-described embodiment, the retractor 9 is fixed to the back panel made of metal. However, the present disclosure is not limited to this. Specifically, the present disclosure may be applicable, for example, to a configuration that does not include the retractor 9, or to a configuration in which the retractor 9 is fixed to the side frame or the upper beam.

In the above-described embodiment, the vehicle seat according to the present disclosure is applied to a car. However, application of the present disclosure is not limited to this. As an alternative, the present disclosure may also be applied to, for example, a seat used in vehicles such as railroad vehicles, ships, or aircrafts, and to a stationary seat used in theaters, at home, or in other places.

Moreover, the present disclosure only has to be consistent with the spirit of the invention recited in the appended claims, and is not limited to the above-described embodiments. Accordingly, the present disclosure may take a configuration in which at least two embodiments among the above-described embodiments are combined together, or a configuration in which any of the diagrammatically-shown constituent elements or the constituent elements described with reference numerals in the above-described embodiments are omitted.

What is claimed is:

1. A back frame used in a seatback of a vehicle seat, the back frame comprising:
a first side frame that is arranged on one end side of the vehicle seat in seat-width directions and that extends in seat up-down directions;
a second side frame that is arranged on the other end side of the vehicle seat in the seat-width directions and that extends in the up-down directions;
a first coupling member extending in the seat-width directions and connecting an upper end portion of the first side frame to an upper end portion of the second side frame;
a recliner provided to change and maintain angles of the first side frame and the second side frame, the recliner being fixed at least to a lower end portion of the first side frame; and
a second coupling member extending in the seat-width directions and connecting the lower end portion of the first side frame to a lower end portion of the second side frame,
wherein the second coupling member is joined to the first side frame at a front portion of the first side frame and at a rear portion of the first side frame, and
wherein a front joined area among joined areas between the second coupling member and the first side frame is positioned at a location corresponding to a joined area between the recliner and the first side frame.

2. The back frame according to claim 1,
wherein the recliner is a first recliner, and the back frame further comprises a second recliner fixed to the lower end portion of the second side frame,
wherein a front joined area among joined areas between the second coupling member and the second side frame is positioned at a location corresponding to a joined area between the second recliner and the second side frame, and
wherein a front-side longitudinally intermediate portion of the second coupling member is positioned rearward relative to both one end and the other end of the second coupling member in a longitudinal direction thereof.

3. The back frame according to claim 2,
wherein a longitudinally intermediate portion of the second coupling member has a substantially C-shaped cross-section with an open upper side.

4. The back frame according to claim 3, the back frame further comprising:
a rod extending in the seat-width directions and coupling the first recliner to the second recliner, and
the longitudinally intermediate portion has a substantially C-shaped cross-section to surround the rod.
